(19) United States
(12) Patent Application Publication
(10) Pub. No.: US 2025/0080910 A1
(43) Pub. Date: Mar. 6, 2025

(54) SPEAKER POSITION DETERMINATION APPARATUS AND ON-VEHICLE SOUND CONTROL SYSTEM

(71) Applicant: HONDA MOTOR CO., LTD., Tokyo (JP)

(72) Inventors: Kosuke SAKAMOTO, Saitama (JP); Takuma MAESAKA, Saitama (JP)

(21) Appl. No.: 18/815,110

(22) Filed: Aug. 26, 2024

(30) Foreign Application Priority Data
Sep. 5, 2023 (JP) 2023-143606

(51) Int. Cl. H04R 5/02; B60K 35/10; H04R 5/027

(52) U.S. Cl. CPC H04R 5/023; B60K 35/10; H04R 5/027; B60K 2360/21; H04R 2205/024; H04R 2499/13

(57) ABSTRACT

A speaker position determination apparatus for determining a position of a speaker built into a headrest includes: a camera configured to capture an image of the headrest; and a position determination device configured to determine the position of the speaker based on the image captured by the camera, wherein the position determination device determines the position of the speaker based on a feature part of the headrest in the image.

### TECHNICAL FIELD

The present invention relates to a speaker position determination apparatus for determining the position of the speaker built into the headrest and an on-vehicle sound control system provided with the speaker position determination apparatus.

### BACKGROUND ART

In recent years, taking into account people in vulnerable situations such as the elderly and children among traffic participants, efforts have been actively made to provide access to sustainable transportation systems for such people. Toward its realization, research and development for further improving the safety and convenience of traffic through development of vehicle comfort are attracting attention.

To improve vehicle comfort, it is desired to reduce the noise inside the vehicle. Therefore, research and development of an active noise control device, which reduces noise by generating canceling sound that is in opposite phase with the noise and making the canceling sound interfere with the noise, are actively conducted.

Conventionally, there is known an active noise control system that includes an adaptive filter to which a noise signal is inputted, an adaptive algorithm execution unit for adaptively updating the transfer function of the adaptive filter, and a speaker for outputting noise cancellation sound according to a noise canceling signal outputted from the adaptive filter. For example, JP7262899B2 discloses an active noise control system in which multiple auxiliary filters for which transfer functions are respectively set corresponding to positions of the occupant's ears (noise cancellation positions) for different seat positions are provided, the microphone output (microphone error signal) outputted from the microphone is corrected by using the output of the auxiliary filter selected depending on the occupant's ear position, and thereafter the adaptive algorithm execution unit adaptively updates the transfer function of the adaptive filter by using the corrected microphone error signal.

Further, JP7262899B2 discloses detecting the head position of the user from the image captured by the camera and the outputs of the sensors configured to detect the position of the seat in the front-rear direction and the tilt of the backrest.

However, in the system disclosed in JP7262899B2, to detect the head position, sensors for detecting the position of the seat and the tilt of the backrest are necessary, and this leads to an increase in the number of components. Also, in recent years, vehicle occupant seats having a speaker built into the headrest are developed. The position of the speaker changes depending on the position of the seat and the tilt of the backrest. Therefore, when the canceling sound is generated from this speaker, it is necessary to accurately determine not only the occupant's ear position but also the position of the speaker that generates the canceling sound.

Incidentally, it is common to configure the headrest such that the height can be adjusted up and down, but a sensor for detecting the headrest height (hereinafter referred to as a headrest sensor) is generally not provided. Therefore, to determine the position of the speaker provided in the headrest, it is necessary to additionally provide a headrest sensor.

### SUMMARY OF THE INVENTION

In view of the foregoing background, a primary object of the present invention is to determine the position of the speaker built into the headrest without a headrest sensor, and thereby to effectively reduce the noise. Furthermore, the present invention aims to contribute to development of a sustainable transportation system.

To achieve the above object, one aspect of the present invention provides a speaker position determination apparatus (18) for determining a position of a speaker (21) built into a headrest (10), the speaker position determination apparatus comprising: a camera (14) configured to capture an image of the headrest; and a position determination device (25, 28) configured to determine the position of the speaker based on the image captured by the camera, wherein the position determination device determines the position of the speaker based on a feature part (41, 42, 43) of the headrest in the image.

According to the above aspect, the speaker position can be determined from the image captured by the camera. Namely, the position of the speaker can be determined without providing a headrest sensor. Also, sensors for detecting the seat position, the backrest angle, and the like are also not necessary.

Preferably, the feature part includes at least three feature points (41) provided on a surface of the headrest (10) at equal distances from a center (21C) of the speaker (21), and the position determination device (25) determines a center of a polygon having vertices at the feature points as a position of the center of the speaker.

According to the above aspect, the center of the speaker position can be determined from the positions of the at least three feature points. Also, even if the speaker is positioned deeper in the headrest than the feature points, the center of the speaker position can be determined from the arrangement of the feature points.

Preferably, the feature part includes a grille (42) provided on the surface of the headrest (10) to cover the speaker (21), and the position determination device (25) determines the position of the speaker based on a position of the grille.

According to the above aspect, since the position of the speaker can be determined from the position of the grille, there is no need to separately provide markers, and the degree of freedom of design improves.

Preferably, the headrest (10) has a microphone (22) built therein, the surface of the headrest is provided with a microphone hole (43), and the position determination device (25) determines the position of the speaker (21) based on a position of the microphone hole.

According to the above aspect, since the position of the speaker can be determined from the position of the microphone hole for allowing the microphone to pick up the sound, there is no need to separately provide markers, and the degree of freedom of design improves.

Further, to achieve the above object, another aspect of the present invention provides an on-vehicle sound control system (1), comprising: the speaker position determination apparatus (18) according to the above aspect; and a controller (23, 24) configured to control the speaker (21) to output canceling sound (y) for canceling noise (d) inside a vehicle, wherein the camera (14) is disposed to further capture an image of a head of an occupant seated in an occupant seat (6) on which the headrest (10) is provided, the position determination device (25) further determines a position of the head of the occupant from the image, and the controller controls the speaker to output the canceling sound based on the position of the head of the occupant and the position of the speaker.

According to the above aspect, since the camera captures an image of the headrest and the head of the occupant, and both the head position and the speaker position can be determined from the image. Therefore, it is possible to control the canceling sound without providing a sensor other than the camera.

Preferably, the position determination device (25) determines presence or absence of a blocking object (44, 45) that blocks a path from the speaker (21) to the occupant's ear in the image, and the controller controls the speaker based on the presence or absence of the blocking object.

Since the camera captures an image of the speaker and the head of the occupant, if there is a blocking object between them, the blocking object appears in the image. According to the above aspect, it is possible to determine the presence or absence of a blocking object from the image without providing a sensor other than the camera. Also, by controlling the canceling sound based on the presence or absence of a blocking object, it is possible to cancel noise more accurately.

Preferably, the on-vehicle sound control system further comprises: a microphone (22) configured to generate an error signal (e) from the noise (d) and the canceling sound (y); a control filter (31) configured to generate a control signal (u) for controlling the speaker (21); and an adaptive update unit (38) configured to perform adaptive update of the control filter based on the error signal, wherein the adaptive update unit stops the adaptive update of the control filter when the blocking object (44, 45) is present.

When the speaker or the microphone is covered, the acoustic characteristics from the speaker to the microphone deviate significantly from the model characteristics set in the controller. According to the above aspect, since the adaptive update unit stops the adaptive update of the control filter, it is possible to prevent the error signal from becoming large so that the canceling sound becomes excessive, and to prevent the adaptive update of the control filter control from becoming unstable.

Preferably, the surface of the headrest (10) is provided with a grille (42) covering the speaker (21), and the position determination device (25) determines that the blocking object (44, 45) is present when the grille is hidden in the image.

According to the above aspect, with a simple method of determining whether the speaker grille is hidden in the image, it is possible to determine the presence or absence of a blocking object.

Preferably, the headrest (10) is provided with a microphone (22), the surface of the headrest is provided with a microphone hole (43), and the position determination device (25) determines that the blocking object is present (44, 45) when the microphone hole is hidden in the image.

According to the above aspect, with a simple method of determining whether the microphone hole is hidden in the image, it is possible to determine the presence or absence of a blocking object.

Preferably, the position determination device (25) determines that the blocking object (44, 45) is present when the occupant's ear is hidden in the image.

According to the above aspect, with a simple method of determining whether the ear is hidden in the image captured for determining the head position, it is possible to determine the presence or absence of a blocking object.

According to the foregoing arrangement, it is possible to determine the position of the speaker built into the headrest, and thereby to effectively reduce the noise.

### BRIEF DESCRIPTION OF THE DRAWINGS

FIG. 1 is a schematic diagram showing a vehicle to which an on-vehicle sound control system according to the first embodiment of the present invention is applied;

FIG. 2 is a functional block diagram showing the on-vehicle sound control system according to the first embodiment;

FIG. 3 is an explanatory diagram of a speaker position and an ear position;

FIGS. 4A and 4B are explanatory diagrams of a first example of a position identification method;

FIGS. 5A and 5B are explanatory diagrams of a second example of the position identification method;

FIGS. 6A and 6B are explanatory diagrams of a third example of the position identification method;

FIG. 7 is an explanatory diagram of a fourth example of the position identification method;

FIG. 8 is a correlation diagram between a relative distance and a correction coefficient;

FIG. 9 is a correlation diagram between a relative distance and an update state of the adaptive filter;

FIG. 10 is an explanatory diagram of an influence of a blocking object;

FIGS. 11A and 11B are explanatory diagrams of a first example of a position identification and blocking object determination method;

FIGS. 12A and 12B are explanatory diagrams of a second example of the position identification and blocking object determination method;

FIG. 13 is a functional block diagram showing an on-vehicle sound control system according to the second embodiment; and

FIG. 14 is a functional block diagram showing an on-vehicle sound control system according to the third embodiment.

### DETAILED DESCRIPTION OF THE INVENTION

In the following, embodiments of the present invention will be described with reference to the drawings. Note that in the following description, “\hat{ }” (circumflex) added to various symbols indicates an identified value or an estimated value. “\hat{ }” is added above each symbol in the drawings, but is added after each symbol in the description.

### First Embodiment

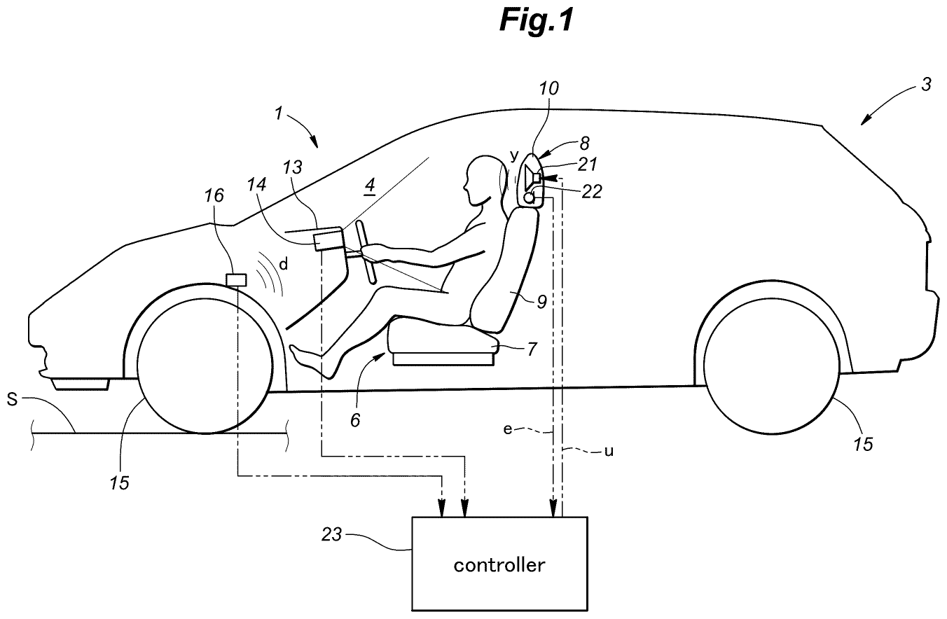

First, the first embodiment of the present invention will be described with reference to FIGS. 1 to 12.

### <Vehicle 3>

FIG. 1 is a schematic diagram showing a vehicle 3 to which an on-vehicle sound control system (hereinafter may be simply referred to as “the sound control system 1”) according to an embodiment is applied. The vehicle 3 is a four-wheeled automobile, for example.

In a vehicle cabin 4 of the vehicle 3, multiple occupant seats 6 are disposed. The multiple occupant seats 6 are arranged in the left-right and front-rear directions but FIG. 1 shows only one occupant seat 6 serving as the driver's seat. Each occupant seat 6 (hereinafter may be simply referred to as “the occupant seat 6”) includes a seat cushion 7 and a reclining part 8 (backrest) connected to a rear portion of the seat cushion 7 to be pivotable with respect to the seat cushion 7. The reclining part 8 includes a seat back 9 and a headrest 10 fixed to the upper end of the seat back 9. In another embodiment, the headrest 10 may be slidably provided on the upper end of the seat back 9.

In an instrument panel 13 of the vehicle 3, an infrared camera 14 is provided. The infrared camera 14 is disposed to face rearward to capture an image of the head of the occupant (the driver) seated in the driver's seat and the headrest 10. Preferably, the infrared camera 14 is disposed in front of the head of the occupant, and may be provided on the rear-view mirror, the sealed glass, the roof lining, or the like of the vehicle 3.

### <Sound Control Apparatus 1>

The sound control system 1 is an apparatus for controlling the sound inside the vehicle cabin 4 of the vehicle 3, and also functions as an active noise control device for reducing noise d generated inside the vehicle cabin 4. More specifically, the sound control system 1 reduces the noise d by generating canceling sound y that is in opposite phase with the noise d and making the generated canceling sound y interference with the noise d.

For example, the noise d to be reduced by the sound control system 1 is road noise caused by vibrations of wheels 15 due to the force from the road surface S. At a part of the vehicle 3 in the vicinity of each wheel 15, a vibration sensor 16 for detecting the vibration corresponding to the noise d is provided. The vibration sensor 16 outputs a reference signal r indicating the vibration corresponding to the noise d. Note that the noise d that may be reduced by the sound control system 1 may be noise other than the aforementioned road noise (for example, driving noise caused by the vibration of a driving source such as an internal combustion engine or an electric motor).

The sound control system 1 includes multiple speakers 21 (which are an example of a canceling sound output device and only one is shown in the drawings) configured to output the canceling sound y for canceling the noise d, and multiple microphones 22 (only one is shown in the drawings) configured to generate an error signal e based on the noise d and the canceling sound y. Further, the sound control system 1 includes a controller 23 for controlling the multiple speakers 21 based on the error signal e.

### <Speaker 21>

Each speaker 21 (hereinafter may be simply referred to as “the speaker 21”) is provided in a manner built into the headrest 10 of the reclining part 8 of the occupant seat 6. Two speakers 21 are disposed at positions corresponding to the left and right ears of the occupant seated in the occupant seat 6 (namely, the two speakers 21 are disposed to be located rearward of the respective ears).

### <Microphone 22>

Each microphone 22 (hereinafter may be simply referred to as “the microphone 22”) is provided in a manner built into the headrest 10 of the reclining part 8 of the occupant seat 6. Two microphones 22 are disposed in positions corresponding to the left and right ears of the occupant seated in the occupant seat 6, for example, below and near the respective speakers 21.

### <Controller 23>

The controller 23 is composed of a computer including an arithmetic processing unit (a processor such as a CPU, an MPU, etc.) and a storage device (a memory such as a ROM, a RAM, etc.). The controller 23 may be configured as one piece of hardware or may be configured as a unit including multiple pieces of hardware.

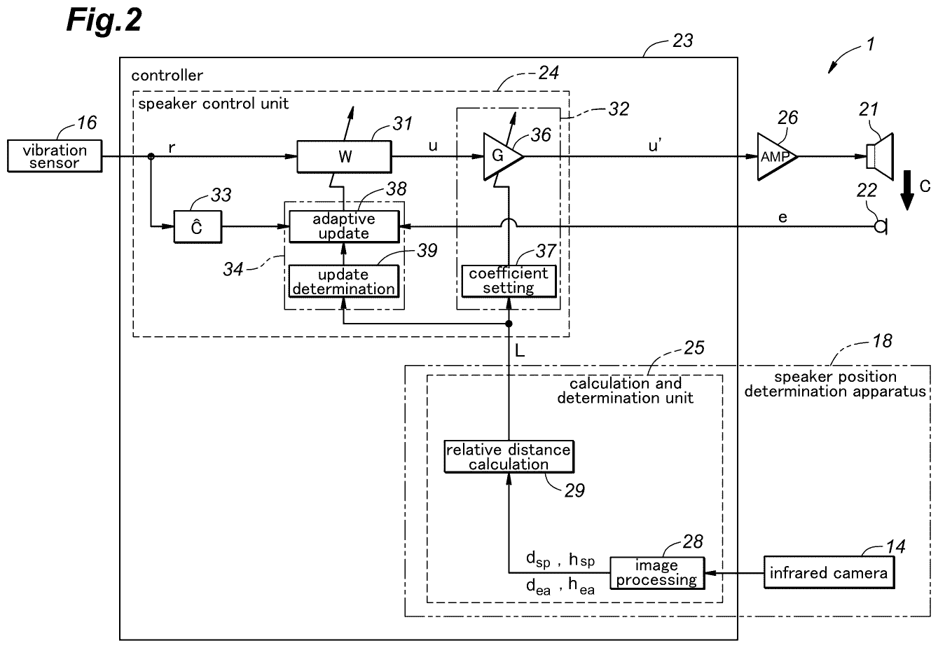

With reference to FIG. 2, the controller 23 includes a speaker control unit 24 and a calculation and determination unit 25 as functional components thereof. Though not shown in the drawings, the controller 23 includes the speaker control unit 24 for each speaker 21 and the calculation and determination unit 25 for each occupant seat 6. The speaker control unit 24 generates a control signal u for the speaker 21 and drives the speaker 21 via an electric power amplifier 26. The calculation and determination unit 25 constitutes computer hardware of a speaker position determination apparatus 18 that determines the position of the speakers 21. In addition to the position of the speakers 21, the calculation and determination unit 25 also determines the position of the occupant's ears. The calculation and determination unit 25 further estimates the distance between each speaker 21 and the corresponding ear of the occupant (hereinafter may be referred to as the relative distance L). Note that the speaker position determination apparatus 18 is provided with the aforementioned infrared camera 14 as another piece of hardware.

In the following, detailed description will be first made of the calculation and determination unit 25, and then of the speaker control unit 24.

### <Calculation and Determination Unit 25>

The calculation and determination unit 25 includes, as functional components thereof, an image processing unit 28 and a relative distance calculation unit 29.

### <Image Processing Unit 28>

The image processing unit 28 performs image processing on the image captured by the infrared camera 14 by using known image processing technology and thereby calculates the head position and the head angle of the occupant. Also, the image processing unit 28 determines the positions of the left and right ears of the occupant by calculation based on the head position and the head angle of the occupant.

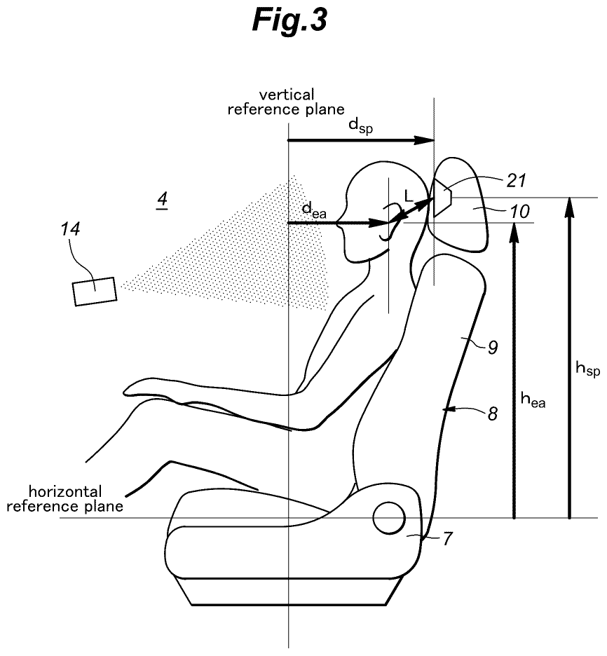

As shown in FIG. 3, the position of each of the left and right ears includes a front-rear position dₑₐ and a vertical position hₑₐ, and is identified by them. The front-rear position dₑₐ is represented by a rearward distance from a vertical reference plane set in a predetermined front-rear position in the vehicle cabin 4. The vertical position hₑₐ is represented by an upward distance from a predetermined horizontal reference plane (for example, a horizontal plane passing the pivot axis of the reclining part 8). The position of each of the left and right ears may further include a left-right position. The left-right position is represented by a lateral distance from the widthwise center of the occupant seat 6, for example. The image processing unit 28 outputs the calculated positions of the left and right ears of the occupant to the relative distance calculation unit 29.

Further, the image processing unit 28 determines the position of each speaker 21 built into the headrest 10 by calculation. As shown in FIG. 3, the position of each speaker 21 includes a front-rear position dₛₚ and a vertical position hₛₚ and is identified by them. The front-rear position dₛₚ of each speaker 21 is represented by a rearward distance from the vertical reference plane common with the front-rear position dₑₐ of the ear. The vertical position hₛₚ of each speaker 21 is represented by an upward distance from the horizontal reference plane common with the vertical position hₑₐ of the ear. The position of each speaker 21 does not change in the left-right direction. In a case where the occupant seat 6 is configured such that the position of each speaker 21 is changeable in the left-right direction, the position of each speaker 21 may further include a left-right position. The left-right position in this case is represented by a lateral distance from the widthwise center of the vehicle 3, for example. The image processing unit 28 outputs the calculated position of each speaker 21 to the relative distance calculation unit 29.

Next, a concrete example of a method for determining the position of the speaker 21 will be described.

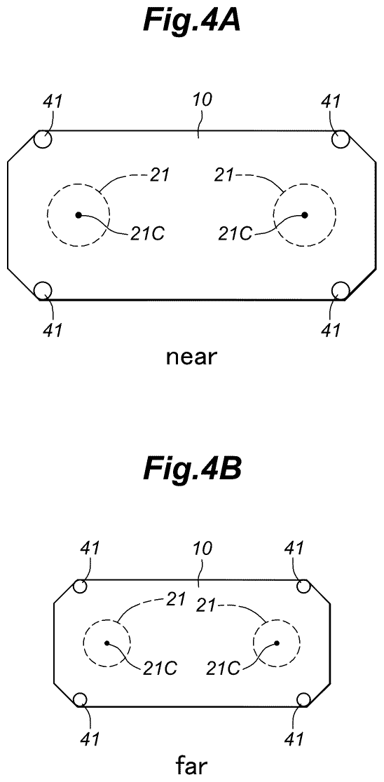

FIGS. 4A and 4B are explanatory diagrams of a first example of the position identification method. FIG. 4A shows an image of the headrest 10 captured by the infrared camera 14 when the headrest 10 is positioned near the infrared camera 14, and FIG. 4B shows an image of the headrest 10 captured by the infrared camera 14 when the headrest 10 is positioned far from the infrared camera 14. The image processing unit 28 extracts feature points of the headrest 10 from the image. The feature points in the illustrated example are four markers 41 provided along the outline of the headrest 10. The image processing unit 28 first determines the front-rear position of the headrest 10 from the positional relationship between the four markers 41.

Specifically, the lateral separation distance between the markers 41 in the image corresponds to the separation distance of the headrest 10 from the infrared camera 14, and the farther rearward the headrest 10 is, the smaller the lateral separation distance between the markers 41 in the image becomes. Accordingly, the image processing unit 28 calculates the front-rear position of the headrest 10 from the lateral separation distance between the markers 41 in the image.

Once the front-rear position of the headrest 10 is identified, the image processing unit 28 can calculate the vertical position (up-down position) of the headrest 10 from the positions of the markers 41 in the image. The image processing unit 28 has data indicating the relationship between the position of the headrest 10 and the position (the center position) of each speaker 21, and determines the position of each speaker 21 based on the calculated position of the headrest 10.

In this way, the image processing unit 28 of the calculation and determination unit 25 determines the position of each speaker 21 based on the feature parts of the headrest 10 in the image. According to this aspect, since the speaker position can be determined from the image captured by the infrared camera 14, sensors for detecting the seat position, the backrest angle, and the like are unnecessary.

Note that it is common to configure the headrest 10 such that the height can be adjusted up and down, but a sensor for detecting the headrest height is generally not provided. Therefore, even if the occupant seat 6 is provided with seat sensors (the front-rear position sensor and the reclining angle sensor), the position of the headrest 10 and the positions of the speakers 21 built into the headrest 10 cannot be determined with only the seat sensors. In contrast, the speaker position determination apparatus 18 of the present embodiment can determine the positions of the speakers 21 without need for a sensor for detecting the headrest height.

In another example, the headrest 10 does not have to be provided with the markers 41. For example, the image processing unit 28 may extract multiple feature points from the outline of the headrest 10 or from patterns, cloth seams, or the like appearing on the surface of the headrest 10, and may identify the position of the headrest 10 from the multiple feature points.

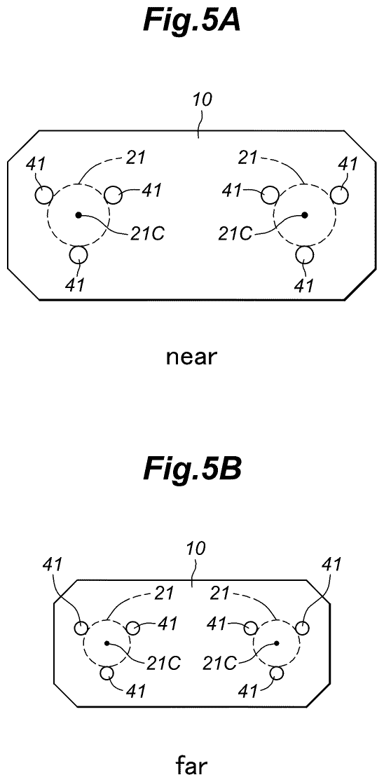

FIGS. 5A and 5B are explanatory diagrams of a second example of the position identification method. FIG. 5A shows an image of the headrest 10 captured by the infrared camera 14 when the headrest 10 is positioned near the infrared camera 14, FIG. 5B shows an image of the headrest 10 captured by the infrared camera 14 when the headrest 10 is positioned far from the infrared camera 14. As in the example shown in FIGS. 4A and 4B, the image processing unit 28 extracts feature points of the headrest 10 from the image. The feature points in the illustrated example are three markers 41 provided around each speaker 21. The three markers 41 for each speaker 21 are provided on the surface of the headrest 10 to be equidistant from the center 21C of the speaker 21. The image processing unit 28 first determines the front-rear position of each speaker 21 from the positional relationship between the three markers 41 related thereto.

Specifically, the distance between the markers 41 and the area of the triangle having vertices on the markers 41 in the image correspond to the separation distance of the headrest 10 from the infrared camera 14, and the farther rearward the headrest 10 is, the smaller they become. Accordingly, the image processing unit 28 calculates the front-rear position of the headrest 10 (namely, the markers 41) from the positional relationship between the markers 41 in the image.

Once the front-rear position of the headrest 10 is identified, the image processing unit 28 can calculate the vertical position of the headrest 10 (namely, the markers 41) from the positions of the markers 41 in the image. The position of the center 21C of each speaker 21 is the center of the three markers 41 provided around it, and the image processing unit 28 determines the position of each speaker 21 based on the calculated positions of the markers 41.

In another example, the headrest 10 may be provided with four or more markers 41 around each speaker 21. With a larger number of markers 41, if some of the markers 41 are hidden by the head of the occupant or the like, the position of the speaker 21 can be determined from the markers 41 that can be seen.

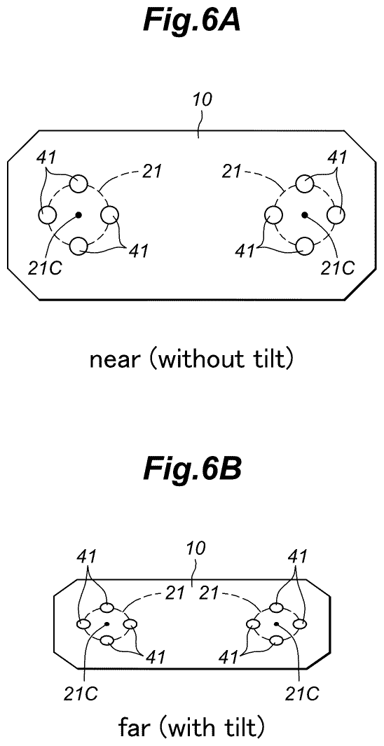

FIGS. 6A and 6B are explanatory diagrams of a third example of the position identification method. FIG. 6A shows an image of the headrest 10 captured by the infrared camera 14 when the headrest 10 is positioned near the infrared camera 14 and faces straight to the infrared camera 14, and FIG. 6B shows an image of the headrest 10 captured by the infrared camera 14 when the headrest 10 is positioned far from the infrared camera 14 and is tilted relative to the infrared camera 14. In other words, the reclining part 8 in FIG. 6B is inclined backward than in FIG. 6.

The feature points in the illustrated example are four markers 41 provided around each speaker 21 to be equidistant from the center 21C of each speaker 21. The image processing unit 28 first determines the front-rear position of the headrest 10 from the positional relationship between the four markers 41.

Specifically, the lateral separation distance between the markers 41 in the image corresponds to the separation distance of the headrest 10 from the infrared camera 14. Accordingly, the image processing unit 28 calculates the front-rear position of the headrest 10 from the lateral separation distance between the markers 41 in the image. Once the front-rear position of the headrest 10 is identified, the image processing unit 28 can calculate the vertical position of the headrest 10 from the positions of the markers 41 in the image.

Further, the image processing unit 28 calculates the tilt angle of the headrest 10 from the ratio of the separation distance between the laterally arranged markers 41 and the separation distance between the vertically arranged markers 41. The image processing unit 28 holds data indicating the relationship between the positions of the markers 41 and the position (the center position) of each speaker 21. In a case where the speakers 21 are disposed inside the surface of the headrest 10, the image processing unit 28 can accurately determine the position of each speaker 21 based on the tilt angle of the headrest 10 and the distance from the surface of the headrest 10 to the speaker 21.

In the examples shown in FIGS. 5A and 5B and FIGS. 6A and 6B, at least three markers 41 (feature points) are provided at positions on the surface of the headrest 10 equidistant from the center 21C of each speaker 21. The image processing unit 28 of the calculation and determination unit 25 determines the center of a polygon having vertices at the at least three feature points as the center position of one speaker 21, and thus can determine the center position of each speaker 21 from the positions of the at least three feature points related thereto. Also, even if the speakers 21 are positioned deeper in the headrest 10 than the feature points, the image processing unit 28 can determine the center position of each speaker 21 from the arrangement of the feature points.

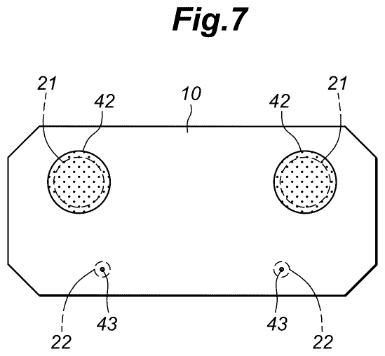

FIG. 7 is an explanatory diagram of a fourth example of the position identification method. In this example, the surface of the headrest 10 is provided with two grilles 42 covering the respective speakers 21. Also, in parts of the surface of the headrest 10 below the grilles 42, two microphone holes 43 are provided at positions aligned with the two microphones 22 built into the headrest 10. The image processing unit 28 extracts the grilles 42 from the image, determines the positions of the grilles 42, and determines the positions of the speakers 21 based on the positions of the grilles 42. Further, the image processing unit 28 extracts the microphone holes 43 from the image, determines the positions of the microphone holes 43, and determines the positions of the speakers 21 based on the positions of the microphone holes 43.

More specifically, the image processing unit 28 is provided with data indicating the shape and size of each grille 42, the distance between the grilles 42, and the positional relationship between each grille 42 and the corresponding speaker 21. Typically, the center position of each grille 42 matches the center position of the corresponding speaker 21. The image processing unit 28 extracts the outline of each grille 42 from the image, and based on the extracted width dimension of each grille 42 or the distance between the grilles 42, first identifies the front-rear position of the grilles 42. Once the front-rear position of the grilles 42 is identified, the image processing unit 28 calculates the vertical position of the center of each grille 42 from the position of each grille 42 in the image, and thereby identifies the position of each grille 42. Then, the image processing unit 28 determines the position of each grille 42, specifically the center position of the outline of each grille 42, as the position of each speaker 21.

In a case where each speaker 21 is separated from the corresponding grille 42 toward inside, the image processing unit 28 may calculates the tilt angle of each grille 42 and the headrest 10 based on the ratio of the width dimension and the height dimension of each grille 42. In this case, by taking into account the tilt of the headrest 10 and the distance between each grille 42 and the corresponding speaker 21, the image processing unit 28 determines the position of each speaker 21 from the position (the center position of the outline) of each grille 42 determined by calculation.

Also, the image processing unit 28 is provided with data indicating the distance between the microphone holes 43 and the positional relationship between each microphone hole 43 and the speaker 21 disposed close thereto. The image processing unit 28 first identifies the front-rear position of the microphone holes 43 based on the distance between the microphone holes 43 extracted from the image. Once the front-rear position of the microphone holes 43 is identified, the image processing unit 28 calculates the vertical position of each microphone hole 43 from the position of each microphone hole 43 in the image, and thereby identifies the position of each microphone hole 43. Then, the image processing unit 28 determines the position of each speaker 21 from the position of each microphone hole 43 determined by calculation and the aforementioned positional relationship.

The image processing unit 28 may determine the position of each speaker 21 by using each grille 42 as a feature part, or may determine the position of each speaker 21 by using each microphone hole 43 as a feature part. Further, the image processing unit 28 may determine the position of each speaker 21 by using each grille 42 and each microphone hole 43 as feature parts.

As described above, by using the grilles 42, the image processing unit 28 of the calculation and determination unit 25 can determine the center of the outline of each grille 42 as the center position of each speaker 21, and therefore, there is no need to separately provide the markers 41 shown in FIG. 3 to FIG. 6B, and the degree of freedom of design improves. Also, by using the microphone holes 43, the image processing unit 28 can determine the positions of the speakers 21 based on the positions of the microphone holes 43. In this case also, there is no need to separately provide the markers 41, and the degree of freedom of design improves.

In addition to determining the position of each speaker 21, the image processing unit 28 determines the presence or absence of a blocking object that blocks the paths from the speakers 21 to the occupant's ears. The determination of the presence or absence of a blocking object will be described in detail later.

### <Relative Distance Calculation Unit 29>

With reference to FIG. 2, the relative distance calculation unit 29 calculates the relative distance L from each speaker 21 to the corresponding ear based on the position of each speaker 21 (the front-rear position dₛₚ, the vertical position hₛₚ) and the positions of the left and right ears of the occupant (the front-rear position dₑₐ, the vertical position hₑₐ) that are inputted thereto. The relative distance calculation unit 29 outputs the calculated relative distance L to the speaker control unit 24.

### <Speaker Control Unit 24>

The speaker control unit 24 includes, as functional components thereof, a control signal generation unit 31, a control signal correction unit 32, a reference signal correction unit 33, and an adaptive correction unit 34. The control signal correction unit 32 includes a correction unit 36 and a coefficient setting unit 37. The adaptive correction unit 34 includes an adaptive update unit 38 and an update determination unit 39.

### <Control Signal Generation Unit 31>

The control signal generation unit 31 of the controller 23 is composed of a control filter W. The control filter W is composed of a finite impulse response (FIR) filter, for example. In another embodiment, the control filter W may be composed of a single frequency adaptive notch (SAN) filter or the like.

The control signal generation unit 31 receives the reference signal r corresponding to the noise d from the vibration sensor 16. In another embodiment, instead of being generated by the vibration sensor 16, the reference signal r may be generated by a reference microphone (not shown in the drawings) configured to generate the reference signal r from the noise d, for example. Alternatively, the reference signal r may be inputted to the control signal generation unit 31 from a component other than the vibration sensor 16 and the reference microphone.

The control signal generation unit 31 generates a control signal u for controlling the speaker 21 by performing, with the control filter W, a filtering process on the reference signal r. The control filter W has a transfer function identified beforehand such that, when the occupant's ear is spaced from the speaker 21 to be within a normal distance range, the canceling sound y that reaches the occupant's ear from the speaker 21 has a phase that is 180° deferent from the phase of the noise d reaching the occupant and the same volume as the volume of the noise d reaching the occupant. The normal distance range will be described later. The control signal generation unit 31 outputs the generated control signal u to the control signal correction unit 32.

### <Control Signal Correction Unit 32>

The control signal correction unit 32 of the controller 23 corrects the control signal u inputted from the control signal generation unit 31 based on the relative distance L from the speaker 21 to the occupant's ear. Specifically, in the control signal correction unit 32, the correction unit 36 is composed of a multiplier and has a correction coefficient G. The correction unit 36 corrects the control signal u with the correction coefficient G, namely, by multiplying the control signal u by the correction coefficient G, and outputs a corrected control signal u′. The correction coefficient G is a sound volume coefficient of the canceling sound y to be generated by the speaker 21.

As the relative distance L between the speaker 21 and the occupant's ear becomes larger (as the ear leaves away from the speaker 21), the canceling sound y that reaches the ear from the speaker 21 becomes smaller. To address this, the correction unit 36 is provided with the correction coefficient G that becomes greater as the relative distance L becomes larger, and corrects the control signal u with the correction coefficient G. In this way, the correction unit 36 can prevent the reduction in the canceling sound y due to increase in the relative distance L with a simple method of correcting the control signal u with the variable correction coefficient G, and therefore, the memory capacity and the calculation amount of the controller 23 can be reduced compared to the case where multiple auxiliary filters are provided.

The correction unit 36 outputs the generated corrected control signal u′ to the electric power amplifier 26. The electric power amplifier 26 supplies the electric power according to the corrected control signal u′ to the speaker 21 and drives the speaker 21. Thereby, the speaker 21 generates the canceling sound y according to the corrected control signal u outputted from the control signal correction unit 32.

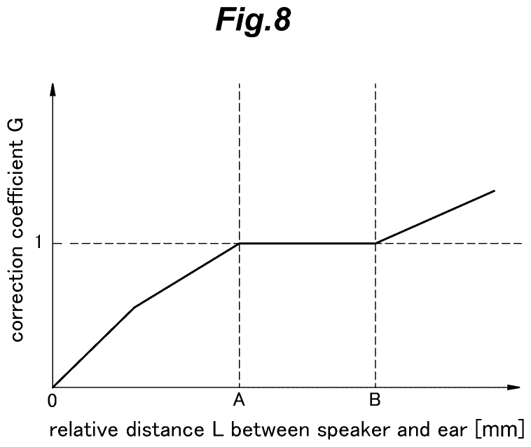

The correction coefficient G of the correction unit 36 is set by the coefficient setting unit 37. The coefficient setting unit 37 sets the correction coefficient G such that the larger the relative distance L from the speaker 21 to the occupant's ear becomes, the greater the correction coefficient G becomes. Specifically, the coefficient setting unit 37 is provided with a gain map represented by a correlation diagram between the relative distance L and the correction coefficient G shown in FIG. 8. The coefficient setting unit 37 refers to this gain map and sets the correction coefficient G to the correction unit 36 according to the inputted relative distance L.

In this gain map, the correction coefficient G is set to monotonically increase with the increase of the relative distance L. Also, in a range from a first threshold A to a second threshold B for the relative distance L (hereinafter referred to as the usual range A-B), the correction coefficient G is set to 1. The usual range A-B is a normal range of the occupant's ear position spaced from the speaker 21. For example, the first threshold A may be 100 mm and the second threshold B may be 175 mm. The correction coefficient G when the relative distance L is 0 may be 0.1 or 0.2, for example.

With reference to FIG. 2 also, the coefficient setting unit 37 sets the correction coefficient G of the correction unit 36 to 1 when the ear is spaced from the speaker 21 to be within the normal distance range (when the relative distance L is in the usual range A-B). When the relative distance L is smaller than the first threshold A, the coefficient setting unit 37 sets the correction coefficient G of the correction unit 36 to a value less than 1. When the relative distance L is larger than the second threshold B, the coefficient setting unit 37 sets the correction coefficient G of the correction unit 36 to a value greater than 1.

### <Reference Signal Correction Unit 33>

The reference signal correction unit 33 is composed of a secondary path filter C\hat{ }. The secondary path filter C\hat{ } is a filter indicating an estimated value of a transfer function of the secondary path from the speaker 21 to the microphone 22. The secondary path filter C\hat{ } is composed of an FIR filter, for example. In another embodiment, the secondary path filter C\hat{ } may be composed of a SAN filter or the like.

The reference signal correction unit 33 generates a canceling sound estimation signal y\hat{ }, which indicates an estimated value of the canceling sound y, by performing a filtering process on the reference signal r with the secondary path filter C\hat{ }. The reference signal correction unit 33 outputs the generated canceling sound estimation signal y\hat{ } to the adaptive update unit 38 of the adaptive correction unit 34.

### <Adaptive Correction Unit 34>

The adaptive update unit 38 of the adaptive correction unit 34 adaptively updates the control filter W constituting the control signal generation unit 31 by using an adaptive algorithm such as an LMS algorithm. More specifically, the adaptive update unit 38 adaptively updates the control filter W so as to minimize the error signal e outputted from the microphone 22.

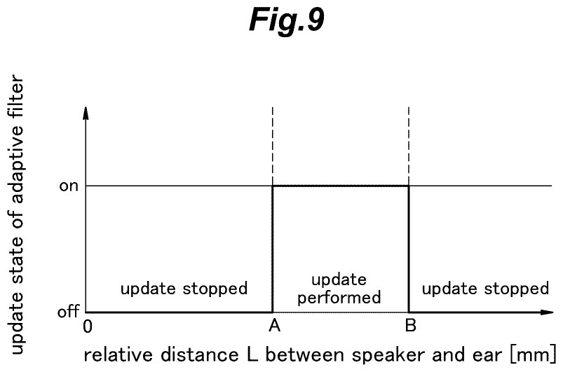

The update determination unit 39 of the adaptive correction unit 34 determines whether the update by the adaptive update unit 38 may be permitted based on the relative distance L between the speaker 21 and the ear. Specifically, as shown in FIG. 9, the update determination unit 39 determines that the adaptive update should be on (permitted or the update may be executed) when the relative distance L is in the usual range A-B from the first threshold A to the second threshold B. Otherwise, the update determination unit 39 determines that the adaptive update should be off (unpermitted or the update should be stopped). The update determination unit 39 outputs the determination result to the adaptive update unit 38.

The adaptive update unit 38 switches the execution/stop of the adaptive update of the control filter W according to the determination result of the update determination unit 39. The adaptive update unit 38 executes the adaptive update of the control filter W only when the determination result is permission. When the determination result is non-permission, the adaptive update unit 38 stops the adaptive update of the control filter W. While the adaptive update is stopped, the control filter W performs the filtering process on the reference signal r with the aforementioned transfer function identified beforehand.

In the embodiment, as described above, each occupant seat 6 is provided with two speakers 21 at positions corresponding to the occupant's ears, and the speaker control unit 24 is provided for each speaker 21. The control signal correction unit 32 of the controller 23 corrects the control signal u outputted from the control filter W based on the relative distance L so that the speaker 21 is controlled based on the corrected control signal u′. In other words, the control signal u is directly corrected based on the relative distance L from the speaker 21 to the occupant's ear. Therefore, the control is simple and the canceling sound y can be controlled quickly to follow the change of the occupant's ear position.

Also, since the sound control system 1 includes the speaker position determination apparatus 18 mentioned above and the infrared camera 14 is disposed to capture an image of the headrest 10 and the head of the occupant, the calculation and determination unit 25 can determine both the position of each speaker 21 and the position of the head of the occupant from the image. Therefore, the controller 23 can control the canceling sound y by driving the speaker 21 based on the position of the head of the occupant and the position of the speaker 21, without provision of a sensor other than the camera.

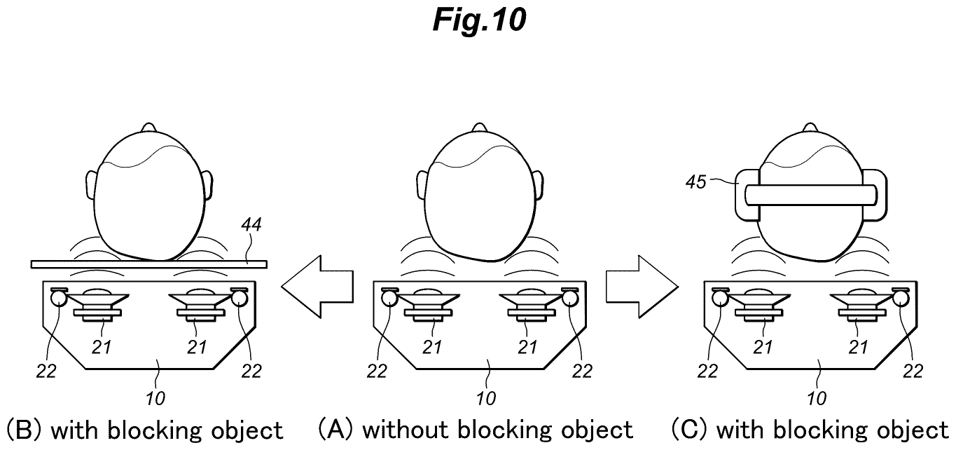

Next, description will be made of the aforementioned determination of the presence or absence of a blocking object. FIG. 10 is an explanatory diagram of an influence of a blocking object. Part (A) of FIG. 10 shows a usual state in which there is no blocking object in the path from the speakers 21 to the occupant's ears. Part (B) of FIG. 10 shows a blocked state in which there is a seat cover 44 as a blocking object in the path from the speakers 21 to the occupant's ears, and part (C) of FIG. 10 shows a blocked state in which there is a headphone 45 as a blocking object in the paths.

In the usual state shown in part (A) of FIG. 10, the speaker control unit 24 corrects the control signal u based on the relative distance L, whereby the noise d is effectively canceled by the canceling sound y at the occupant's ear position. However, in the blocked state shown in part (B) or (C) of FIG. 10, the volume of the canceling sound y transmitted from the speakers 21 to the occupant's ears is reduced, and hence, the effect of canceling the noise d by the canceling sound y is reduced. Therefore, the image processing unit 28 of the speaker position determination apparatus 18 shown in FIG. 2 determines the presence or absence of a blocking object, and the speaker control unit 24 controls the speaker 21 based on the presence or absence of a blocking object.

In other words, since the infrared camera 14 captures an image of the speakers 21 and the head of the occupant, if there is a blocking object therebetween, the blocking object appears in the image. Thus, the sound control system 1 of the present embodiment determines the presence or absence of a blocking object from the image without use of a sensor other than the camera, controls the canceling sound y based on the presence or absence of a blocking object thereby to accurately cancel the noise d, as will be described in detail below.

Note that in Europe (Euro-NCAP: European New Car Assessment Programme), equipment with a function to detect the driver looking away and to issue a warning is highly evaluated. Accordingly, driver monitoring cameras are becoming standard equipment. Thus, the image-based determination of the position of the head of the occupant, the position of the speaker 21, the presence or absence of a blocking object, or the like may be performed by using the driver monitoring camera. Thereby, there is no need to prepare a dedicated camera.

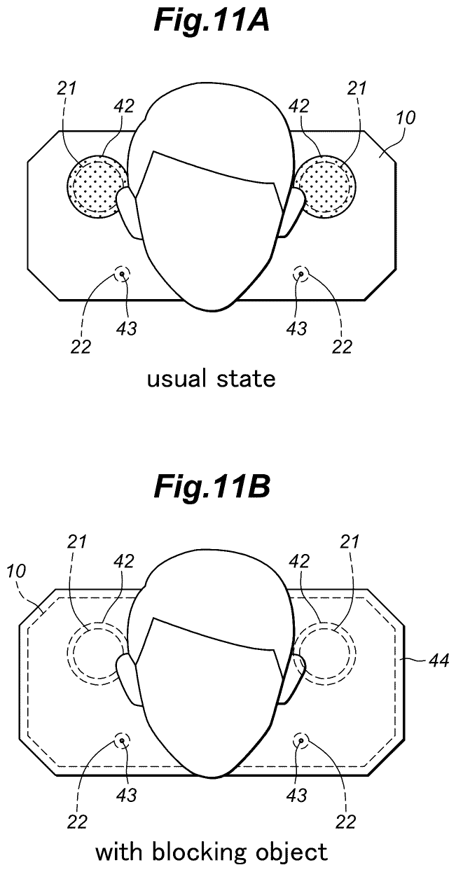

FIGS. 11A and 11B are explanatory diagrams of a first example of a position identification and blocking object determination method. As shown in FIG. 11A, in this example, the surface of the headrest 10 is provided with two grilles 42 covering the respective speakers 21, and two microphone holes 43 provided below the respective grilles 42, as in the fourth example shown in FIG. 7. These grilles 42 and microphone holes 43 are used as feature parts for determining the positions of the speakers 21.

On the other hand, when the headrest 10 is covered with the seat cover 44 as shown in FIG. 11B, the seat cover 44 blocks the path from the speakers 21 to the occupant's ears. Also, the seat cover 44 covers and hides from view the grilles 42 and the microphone holes 43 which are feature parts for the position determination. Therefore, the image processing unit 28 of FIG. 2 cannot determine the positions of the speakers 21 from the feature parts.

In this case, when the grilles 42, which are the feature parts, are hidden and cannot be extracted, the image processing unit 28 determines that there is a blocking object in the path from the speakers 21 to the occupant's ears. In other words, the image processing unit 28 can determine the presence or absence of a blocking object with a simple method of determining whether the grilles 42 for the speakers 21 are hidden.

Also, when the microphone holes 43, which are the feature parts, are hidden and cannot be extracted, the image processing unit 28 determines that there is a blocking object in the path from the speakers 21 to the occupant's ears. In other words, the image processing unit 28 can determine the presence or absence of a blocking object with a simple method of determining whether the microphone holes 43 are hidden.

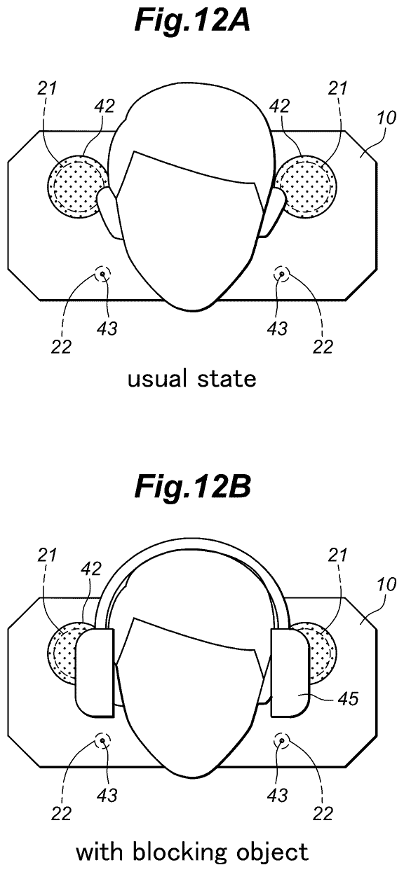

FIGS. 12A and 12B are explanatory diagrams of a second example of the position identification and blocking object determination method. As shown in FIG. 12A, in this example also, the surface of the headrest 10 is provided with two grilles 42 covering the respective speakers 21, and two microphone holes 43 provided below the respective grilles 42, as in the fourth example shown in FIG. 7. These grilles 42 and microphone holes 43 are used as feature parts for determining the positions of the speakers 21.

On the other hand, as shown in FIG. 12B, when the occupant puts on the headphone 45, the headphone 45 blocks the path from the speakers 21 to the occupant's ears. Also, the headphone 45 covers and hides from view parts of the grilles 42, which are the feature parts for the position determination, and in addition, covers and hides from view the occupant's ears. In such a case, the image processing unit 28 of FIG. 2 may not be able to determine the positions of the speakers 21 from the feature parts.

When parts of the grilles 42 cannot be extracted and the occupant's ears cannot be extracted, the image processing unit 28 determines that there is a blocking object in the path from the speakers 21 to the occupant's ears. In other words, the image processing unit 28 can determine the presence or absence of a blocking object with a simple method of determining whether the occupant's ears are hidden.

Upon determination of the presence or absence of a blocking object, the image processing unit 28 of FIG. 2 outputs the determination result to the speaker control unit 24. When the determination result that there is a blocking object is inputted to the speaker control unit 24, the update determination unit 39 of the speaker control unit 24 determines that the adaptive update should be off (unpermitted or the update should be stopped) regardless of whether the relative distance L is within the usual range A-B. Accordingly, the adaptive update unit 38 stops the adaptive update of the control filter W.

When the speaker 21 or the microphone 22 is covered, the acoustic characteristics C from the speaker 21 to the microphone 22 deviate significantly from the model characteristics set in the secondary path filter C\hat{ } constituting the reference signal correction unit 33. In the present embodiment, since the adaptive update unit 38 stops the adaptive update of the control filter W, it is possible to prevent the error signal e from becoming large so that the canceling sound y becomes excessive, and to prevent the adaptive update control of the control filter W from becoming unstable.

Also, when the determination result that there is a blocking object is inputted to the speaker control unit 24, the coefficient setting unit 37 of the control signal correction unit 32 sets the correction coefficient G to a value greater than the value corresponding to the relative distance L shown in FIG. 8. For example, the coefficient setting unit 37 sets the correction coefficient G to a value 1.5 times the value shown in FIG. 8. This increases the volume of the canceling sound y transmitted from the speaker 21 to the occupant's ear, which is reduced by the blocking object, and thus, the effect of canceling the noise d by the canceling sound y improves.

In this way, the noise d can be canceled more accurately due to the control of the speakers 21 by the speaker control unit 24 based on the presence or absence of a blocking object.

Note that in the present embodiment, when the determination that there is a blocking object is inputted to the speaker control unit 24, the update determination unit 39 stops the adaptive update of the control filter W and the coefficient setting unit 37 increases the correction coefficient G, but the speaker control unit 24 may perform control that is different from this. For example, the speaker control unit 24 may stop the output itself of the canceling sound y. By stopping the output itself of the canceling sound y, amplification of the noise d audible to the ear due to the change of the acoustic characteristics C can be prevented. Alternatively, the update determination unit 39 may stop the adaptive update of the control filter W while the coefficient setting unit 37 may set the correction coefficient G to the usual value shown in FIG. 8.

### Second Embodiment

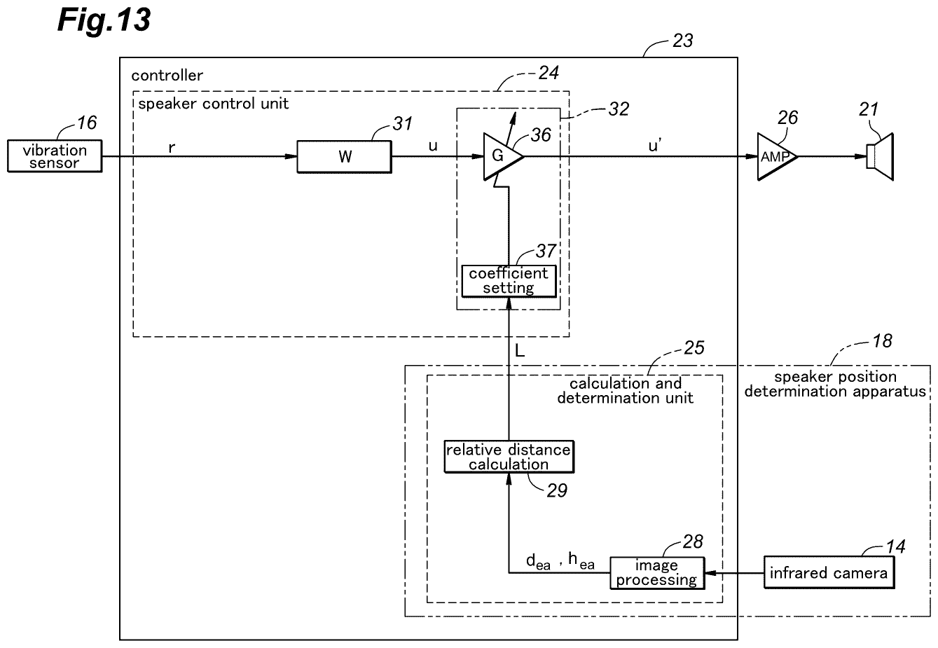

Next, the second embodiment of the present invention will be described with reference to FIG. 13. Note that the elements same as or similar to those of the first embodiment are denoted by the identical reference signs and redundant description will be omitted. Unless otherwise mentioned, this applies to the following embodiments.

The sound control system 1 of this embodiment differs from the first embodiment in that the sound control system 1 is not provided with a microphone 22 and the speaker control unit 24 of the controller 23 has a different configuration. Specifically, the speaker control unit 24 does not include the reference signal correction unit 33 (FIG. 2) and the adaptive correction unit 34 (FIG. 2). In other words, in the speaker control unit 24, the adaptive update of the control filter W is not performed, and the correction of the control signal u using of the coefficient based on the relative distance L from the speaker 21 to the occupant's ear is performed by the control signal correction unit 32.

When the determination result that there is a blocking object is inputted to the speaker control unit 24, the coefficient setting unit 37 of the speaker control unit 24 sets the correction coefficient G to a value greater than the value corresponding to the relative distance L shown in FIG. 8. This increases the volume of the canceling sound y transmitted from the speaker 21 to the occupant's ear, which is reduced by the blocking object, and thus, the effect of canceling the noise d by the canceling sound y improves.

Alternatively, when it is determined that there is a blocking object, the coefficient setting unit 37 may set the correction coefficient G to 0, thereby to stop the output itself of the canceling sound y. By stopping the output itself of the canceling sound y, amplification of the noise d audible to the ear due to the change of the acoustic characteristics C is prevented.

### Third Embodiment

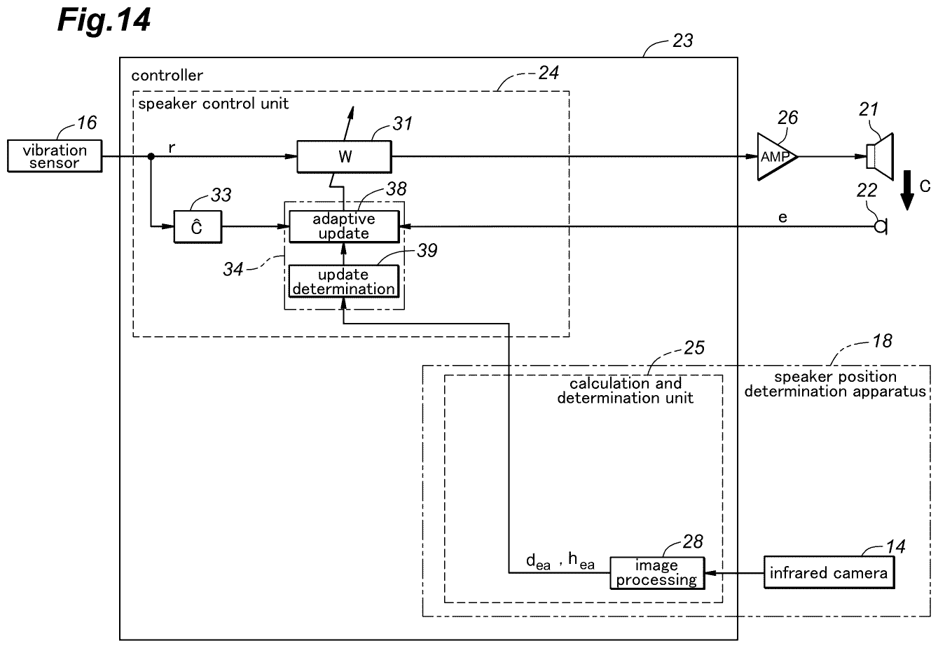

Next, the third embodiment of the present invention will be described with reference to FIG. 14. The sound control system 1 of this embodiment differs from the first embodiment with respect to the configuration of the controller 23. Specifically, the speaker control unit 24 is not provided with the control signal correction unit 32 (FIG. 2), and the calculation and determination unit 25 of the speaker position determination apparatus 18 is not provided with the relative distance calculation unit 29. In other words, in the calculation and determination unit 25, the image processing unit 28 determines the positions of the speakers 21 by extraction of the grilles 42 or the microphone holes 43, the position determination is performed to determine the presence or absence of a blocking object. Upon determination of the presence or absence of a blocking object, the image processing unit 28 outputs the determination result to the speaker control unit 24.

When the determination that there is a blocking object result is inputted to the speaker control unit 24, the update determination unit 39 of the speaker control unit 24 determines that the adaptive update should be off (unpermitted of the update should be stopped). Accordingly, the adaptive update unit 38 stops the adaptive update of the control filter W.

When the speaker 21 or the microphone 22 is covered, the acoustic characteristics C from the speaker 21 to the microphone 22 deviate significantly from the model characteristics set in the secondary path filter C\hat{ } constituting the reference signal correction unit 33. In this embodiment also, since the adaptive update unit 38 stops the adaptive update of the control filter W, it is possible to prevent the error signal e from becoming large so that the canceling sound y becomes excessive, and to prevent the adaptive update control of the control filter W from becoming unstable.

Concrete embodiments have been described in the foregoing, but the present invention can be modified in various ways without being limited to the above embodiments. For example, in the above embodiments, the infrared camera 14 was used to capture an image of the headrest 10, but the camera is not limited to this, and a thermal camera capable of detecting heat, a camera for capturing an image with natural light, or the like may be used. Also, in the above embodiments, a single camera was provided in the instrument panel 13, but multiple cameras may be provided in the instrument panel, and the multiple cameras may be provided in mutually different positions. Besides, the concrete structure, arrangement, number, material or the like of each member or part described in the above embodiments may be appropriately changed without departing from the spirit of the present invention. Also, part or all of the above embodiments may be combined to each other. Also, not all of the components shown in the above embodiments are necessarily indispensable and they may be selectively adopted as appropriate.

1. A speaker position determination apparatus for determining a position of a speaker built into a headrest, the speaker position determination apparatus comprising:
a camera configured to capture an image of the headrest; and
a position determination device configured to determine the position of the speaker based on the image captured by the camera,
wherein the position determination device determines the position of the speaker based on a feature part of the headrest in the image.

2. The speaker position determination apparatus according to claim 1, wherein the feature part includes at least three feature points provided on a surface of the headrest at equal distances from a center of the speaker, and
the position determination device determines a center of a polygon having vertices at the feature points as a position of the center of the speaker.

3. The speaker position determination apparatus according to claim 1, wherein the feature part includes a grille provided on the surface of the headrest to cover the speaker, and
the position determination device determines the position of the speaker based on a position of the grille.

4. The speaker position determination apparatus according to claim 1, wherein the headrest has a microphone built therein,
the surface of the headrest is provided with a microphone hole, and
the position determination device determines the position of the speaker based on a position of the microphone hole.

5. An on-vehicle sound control system, comprising:
the speaker position determination apparatus according to claim 1; and
a controller configured to control the speaker to output canceling sound for canceling noise inside a vehicle,
wherein the camera is disposed to further capture an image of a head of an occupant seated in an occupant seat on which the headrest is provided,
the position determination device further determines a position of the head of the occupant from the image, and
the controller controls the speaker to output the canceling sound based on the position of the head of the occupant and the position of the speaker.

6. The on-vehicle sound control system according to claim 5, wherein the position determination device determines presence or absence of a blocking object that blocks a path from the speaker to the occupant's ear in the image, and
the controller controls the speaker based on the presence or absence of the blocking object.

7. The on-vehicle sound control system according to claim 6, further comprising:
a microphone configured to generate an error signal from the noise and the canceling sound;
a control filter configured to generate a control signal for controlling the speaker; and
an adaptive update unit configured to perform adaptive update of the control filter based on the error signal,
wherein the adaptive update unit stops the adaptive update of the control filter when the blocking object is present.

8. The on-vehicle sound control system according to claim 6, wherein the surface of the headrest is provided with a grille covering the speaker, and
the position determination device determines that the blocking object is present when the grille is hidden in the image.

9. The on-vehicle sound control system according to claim 6, wherein the headrest is provided with a microphone,
the surface of the headrest is provided with a microphone hole, and
the position determination device determines that the blocking object is present when the microphone hole is hidden in the image.

10. The on-vehicle sound control system according to claim 6, wherein the position determination device determines that the blocking object is present when the occupant's ear is hidden in the image.
